(19) United States
(12) Patent Application Publication
(10) Pub. No.: US 2009/0036096 A1
(43) Pub. Date: Feb. 5, 2009

(54) USING AN AUTHENTICATION TICKET TO INITIALIZE A COMPUTER

(76) Inventor: Wael M. Ibrahim, Cypress, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/830,605

(22) Filed: Jul. 30, 2007

(51) Int. Cl. H04M 1/66

(52) U.S. Cl. 455/411

(57) ABSTRACT

A method comprises authenticating a wireless communication device, receiving an authentication ticket from a server if the wireless communication device is successfully authenticated, and providing the authentication ticket by the wireless communication device to a computer to enable the computer complete an initialization process.

### BACKGROUND

Many computer systems require a user to enter a password to complete an initialization process. For example, at least some operating systems prompt a user to enter a password to enable the operating system to be initialized. A user, however, may forget the password thereby precluding the initialization process, or whatever process requires the password, from being completed.

### BRIEF DESCRIPTION OF THE DRAWINGS

For a detailed description of exemplary embodiments of the invention, reference will now be made to the accompanying drawings in which:

FIG. 1 shows a system in accordance with various embodiments;

FIG. 2 shows a method in accordance with various embodiments;

FIG. 3A shows a method of authenticating a user and a mobile communication device in accordance with various embodiments; and

FIG. 3B shows another method of authenticating the user and mobile communication device in accordance with various embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

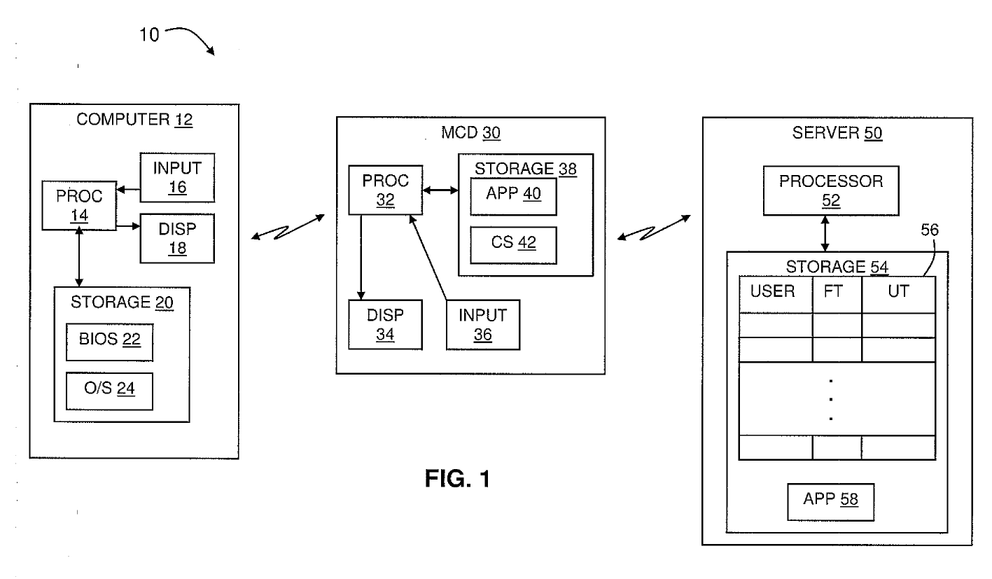

FIG. 1 illustrates a system 10 in accordance with various embodiments. As shown, system 10 comprises a computer 12, mobile communication device (MCD) 30, and a server 50. The mobile communication device 30 comprises a cell phone in at least some embodiments, but may comprise other types of mobile communication devices in other embodiments such as a smart phone or personal digital assistant (PDA). The mobile communication device 30 is capable of wireless communication with the computer 12 and server 50. In various embodiments, the mobile communication device 30 wirelessly communicates with the computer 12 and server 50 or wirelessly communicates with intermediary devices. For example, as a cell phone, the mobile communication device 30 wirelessly communicates with base stations and, through the telephone system and various wide and local area networks, to the server 50. In some embodiments, the wireless communication link between the mobile communication device 30 and the computer 12 comprises a radio frequency (RF) link such as in accordance with the Bluetooth protocol.

The computer 12 comprises a processor 14 coupled to an input device 16, a display device 18 and storage 20. The input device 16 comprises a keyboard and/or a pointing device such as a mouse or trackball. The display device comprises any suitable type of display such as a liquid crystal display (LDC) display, a cathode ray tube (CRT) display, etc. The storage 20 comprises volatile memory (e.g., random access memory), non-volatile storage (e.g., hard disk drive, Flash memory, compact disk read-only memory (CD ROM), etc.), or combinations thereof. The storage 20 comprises at least a basic input/output system (BIOS) 22 and an operating system 24. The BIOS 22 and operating system 24 comprise code that is executable by the processor 14. The BIOS 22 provides various low-level functions for the computer 12 and the operating system 24 provides a platform on which various applications run. The BIOS 22 and/or operating system 24, when executed by processor 14, enables the computer 12 to perform some or all of the functionality described herein attributed to the computer 12.

Referring still to FIG. 1, the mobile communication device 30 comprises a processor 32 coupled to a display 34, input device 36 and storage 38. The display 34 comprises, for example, an LCD display such as is typical of cell phones. The input device 36 comprises a numeric keypad, such as is typically found on cell phones, or a keyboard. The storage 38 comprises volatile memory (e.g., random access memory), non-volatile storage (e.g., hard disk drive, Flash memory, compact disk read-only memory (CD ROM), etc.), or combinations thereof. The storage 38 comprises an application 40 and system certificate (CS) storage 42. The application 40, when executed by processor 32, enables the mobile communication device 30 to perform some or all of the functionality described herein attributed to the mobile communication device.

The server 50 comprises a processor 52 coupled to storage 54. The storage 54 comprises volatile memory (e.g., random access memory), non-volatile storage (e.g., hard disk drive, Flash memory, compact disk read-only memory (CD ROM), etc.), or combinations thereof. As shown in the illustrative embodiment of FIG. 1, storage 54 comprises an authentication table 56 and an application 58. The application 58 comprises code that is executable by processor 52. The application 58, when executed by processor 52, enables the server 50 to perform some or all of the functionality described herein attributed to the server.

In accordance with at least some embodiments, an executable code such as the operating system 24 requires being provided with a correct password before the initialization of the code (e.g., operating system) can be completed. The example provided herein is in the context of a password being used to enable the operating system to complete its initialization process. However, any application that requires a password to complete its load and initialization can be initialized in accordance with the techniques described herein.

In the event the user forgets the password, or for any other reason or no reason at all, the mobile communication device 30 can be used to enable the operating system 24 to complete its initialization process without the user entering the password. In general, the mobile communication device 30 and the user of the mobile communication device are authenticated. Once the mobile communication device 30 and the user are authenticated, the sever 50 provides an “authentication ticket” to the mobile communication device 30. The mobile communication device 30 forwards the authentication ticket to the computer 12. The computer 12 authenticates the ticket. Once the ticket has been successfully authenticated, the BIOS 22 provides the password to the operating system 24 to complete the initialization process.

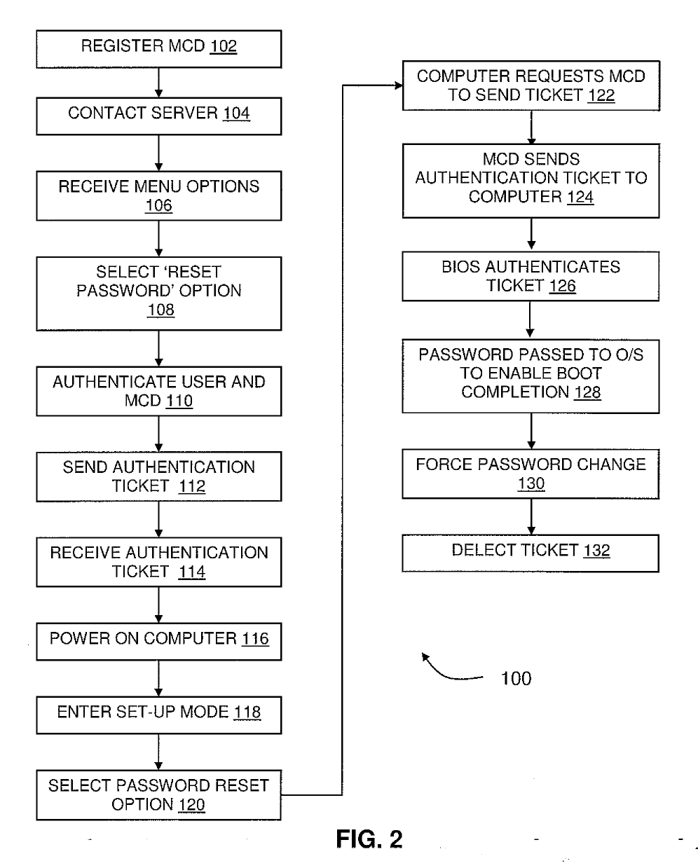

FIG. 2 illustrates a method 100 in accordance with various embodiments. The actions attributed to each of the computer 12, mobile communication device 30, and server 50 are implemented by the respective device's processor (i.e., 14, 32, and 52) executing the relevant executable code.

At 102, method 100 comprises registering the mobile communication device 30. Registering the mobile communication device 30 comprises collecting one or more pieces of information pertaining to the mobile communication device. At least some or all of the collected information is unique to the particular mobile communication device. Examples of the information collected during the registration process comprises the serial number, phone number, name of user of the mobile communication device 30, information from a subscriber identity module (SIM) card (e.g., encoded network identification, person identification numbers, etc.), information stored in, or generated by, a trusted platform module (TPM) (e.g., non-migratable key, storage root key), etc. The collected information is referred to as the mobile communication device's “fingerprint” (FP) and is provided to, and stored in, the database 56 of the server's storage 54, and is referred to as a fingerprint template (FT). The collected information may be concatenated or otherwise combined together and may be encrypted and signed as desired. In some embodiments, unique information pertaining to the user of the mobile communication device may also be collected and stored in the server's database 56. This information is referred to as a user template (UT) and may comprise such user-specific data as a password, retinal scan image, etc. The mobile communication device 30 may comprise a biometric sensor (e.g., retinal scanner) to acquire such data. The database 56 thus comprises, for each user, a fingerprint template of that user's mobile communication device 30 and/or a user template associated with the user.

At 104, the mobile communication device 30 contacts the server 50. This action may be performed if, for example, the user of the computer 12 forgets the password, although there need not be any particular reason for establishing contact between the mobile communication device 30 and the server 50. That is, the user can use the mobile communication device 30 to contact the server 50 even if the user has not forgotten the password. In at least some embodiments, action 104 is performed by a user using the mobile communication device to dial an automated service hosted on the server 50. The application 58 implements the automated service. Such an automated service performs some or all of the functionality described herein attributed to the server 50. While in some embodiments, the action 104 is performed by a user using the mobile communication device 30 to call an automated service hosted on the server 50, in other embodiments, the mobile communication device contacts the server 50 by way of a short message service (SMS) or by way of a web browser (e.g., via hyper text transport protocol (HTTP)).

At 106, the server 50 provides, and the mobile communication device 30 receives, one or more menu options. The menu options comprise one or more selectable user-services hosted on the server 50. The mobile communication device 30 causes the menu option(s) to be provided to the user of the mobile communication device 30 by way of display 34, or by way of audible annunciations. At 108, the user selects the menu option corresponding to resetting the computer's password.

Upon selecting the “reset password” menu option, both the user and the mobile communication device 30 are authenticated (110). In at least some embodiments, user authentication may entail the user entering an alphanumeric value assigned to the user (e.g., social security number, employee number, etc.) on the mobile communication device 30. Authentication of the mobile communication device 30 may comprise obtaining one or more pieces of information associated with the mobile communication device. Such pieces of information comprise at least one value that is unique to the mobile communication device 30 (e.g., serial number). In at least some embodiments, the obtained information associated with the mobile communication device 30 comprises the same type of information that was used to register the mobile communication device 30 (block 102). Such information obtained in block 110 thus should match the information provided to the server 50 during the registration process. If the information obtained from the mobile communication device 30 matches the information (the device's “fingerprint”) stored in the server 50 during the registration process for that device, then the mobile communication device 30 is deemed authenticated; otherwise, the mobile communication device 30 is not deemed authenticated.

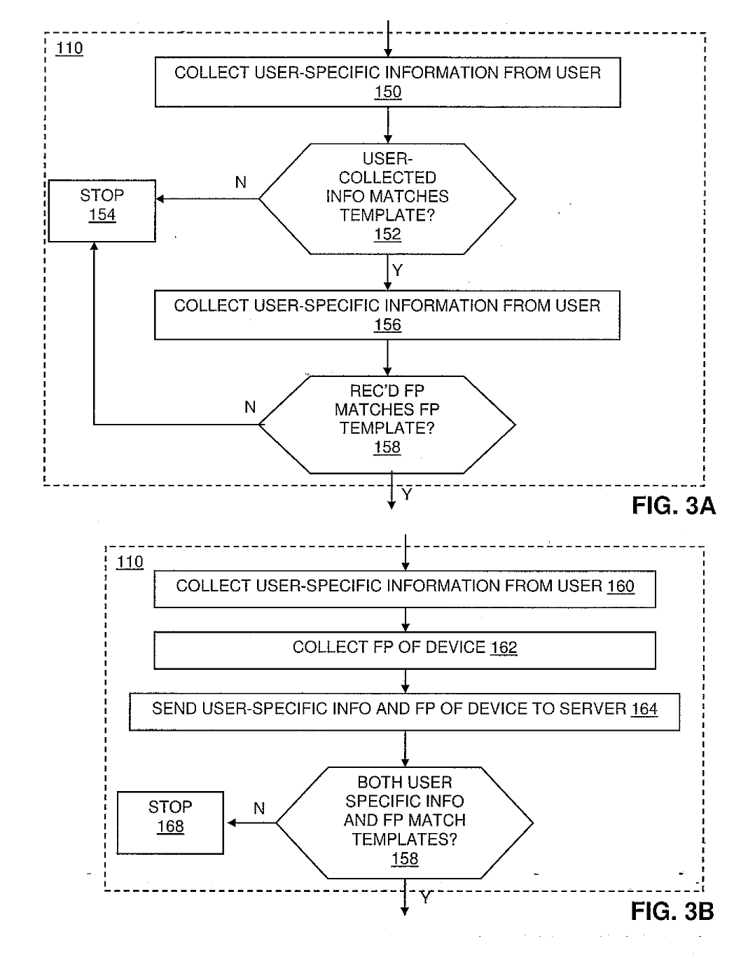

FIG. 3A illustrates one embodiment of authenticating, per block 110, the user and mobile communication device 30. At 150, user-specific information is collected from, or associated with, the user using the mobile communication device 30. Examples of such user-specific information comprise a password, biometrics (e.g., user's fingerprint or retinal scan), etc. At 152, the mobile communication device 30 compares the user-collected information to information previously stored in the mobile communication device 30. For example, in the case of retinal scan information or a password, the user previously scans his or her retina or enters a password for storage in the mobile communication device 30. If the user-collected information from 150 does not match the stored information, then the process stops at 154 in accordance with at least some embodiments. If, however, the user-collected information from 150 does match the stored information, then at 156, the fingerprint of the mobile communication device 30 is collected and sent to the server 50. That the server 50 receives the mobile communication device's fingerprint indicates to the server 50 that the user was successfully authenticated at 150-152. In this embodiment, the server 50 thus does not separately authenticate the user; the mobile communication performs that action. At 158, the server 50 determines whether the mobile communication device's fingerprint matches a fingerprint template (FT) for the mobile communication device previously stored in the server 50 during the registration process. If the device's finger does not match the fingerprint template for the device stored in the server 50, then in at least some embodiments, the process stops at 154. In other embodiments, the process continues even if the fingerprints do not match, but the user is granted limited access the computer 12 once the initialization process completes. Such limited access comprises having access to some, but not all, files, read only access to certain files, etc. If at 158, the device's fingerprint does match the server's fingerprint template, then the control continues (FIG. 2, 112).

In some embodiments, control continues from 158 thereby enabling the computer to complete its initialization process, albeit with limited access, as long as at least one of the user or mobile communication device 30 is successfully authenticated. If both the user and the mobile communication device 30 are successfully authenticated, full access to the computer is granted.

FIG. 3B illustrates another embodiment of authenticating the user and mobile communication device 30. In the illustrative embodiment of FIG. 3B, user-specific information and the mobile device's fingerprint are collected at 160 and 162, respectively, by the mobile communication device 30. At 164, the user-specific information and the device's fingerprint are sent from the mobile communication device 30 to the server 50. At 166, the server 50 compares the received user-specific information and the device's fingerprint to the fingerprint template (FT) for the device and the user template (UT) for the user stored on the server 50 in database 56. If both the received user-specific information and the device's fingerprint match the UT and FT stored in the server 50, control continues at FIG. 2, block 112. If there is not a match of both the user-specific information and the device's fingerprint to the templates stored in the server 50, the process stops at 168. As noted above, if one, but not both, of the user-specific information or the device fingerprint matches the corresponding UT and FT stored in the server 50, control may still continue to boot the computer 12, but with the user being granted limited access to the computer.

At 112, the server 50 transmits an authentication ticket to the mobile communication device 30. In accordance with various embodiments, the authentication ticket comprises a value that is generated “on the fly” by the server 50. The authentication ticket comprises a value that is used only once, in various embodiments, to enable initialization completion of the computer 12. The authentication ticket may comprise, for example, such fields as the date through which the ticket is considered valid, a count indicating the number of times the ticket can be used (e.g., 1), a flag indicating that the password can or must be changed, an encryption passphrase that is used to unwrap (e.g., decrypt) the password saved in the BIOS. The authentication ticket is encrypted and signed using a private key in accordance with at least some embodiments. At 114, the mobile communication device 30 receives the authentication ticket, which the mobile communication device 30 stores in system certificate storage 42 (FIG. 1).

A message or other form of annunciation may be provided at this time to the user of the mobile communication device 30 to alert the user that the user can boot up the computer 12. At 116, the user powers on the computer 12. In various embodiments, during the boot process, the user causes the computer 12 to transition to a set-up mode of operation (118). In at least some embodiments, this action may be performed by pressing the “F10” key during the boot process. The computer's BIOS 22 executes to implement the set-up mode. Once in the set-up mode of operation, the BIOS 22 provides the user with one or more options on display 18. The options enable the user to perform various activities such as viewing or changing the configuration of the computer 12.

At least one of the options comprises an option whereby the password can be reset with the assistance of the mobile communication device 30. The user selects this option at 120 upon which the BIOS 22, at 122, requests the mobile communication device 30 to wirelessly send an authentication ticket. At 124, the mobile communication device 30 sends the authentication ticket from system certificate storage 42 to the computer 12. At 126, the BIOS 22 authenticates the authentication ticket received from the mobile communication device 30. This action is performed in accordance with at least some embodiments by using a public key counterpart to the private key that was used to encrypt and sign the authentication ticket as discussed above, in the case in which the authentication ticket was signed with a private key. The public key is provided to and stored on the computer 12. If the authentication ticket is successfully authenticated by the computer's BIOS 22 at 124, then at 128, the relevant password (the password that the user presumably forgot) is passed to the executable application that uses the password. In various embodiments, the password is stored in BIOS 22, on the read-only memory in which the BIOS 22 is stored, or in other storage. If the password is encrypted, the BIOS 22 may decrypt the password before or upon passing it to the executable application that is to use the password. In the example of FIG. 2, the password is passed to the operating system 24 which uses the password to complete the initialization of the operating system. In accordance with some embodiments, the password is not displayed or otherwise provided to the user. In other embodiments, the password is displayed or otherwise provided to the user.

In accordance with various embodiments, the computer 12, via, for example, the BIOS 22 or operating system 24, forces the user to change the password at 130. The user is prompted to enter a new password which is then used in place of the old password that the user presumable had forgotten. If desired, the user can be prompted multiple times (e.g., twice) to enter a new password. The new password is used only if there is a match among the multiple instances of the password typed in by the user. In other embodiments, the user is not forced to change the password. In some embodiments, the user can change the password via another option provided to the user while in the set up mode. For example, the subsequent time the user boots the computer 12, the user can cause BIOS to enter the set-up mode during which the user can change the password.

The authentication ticket provided to the computer 12 may be automatically deleted by the BIOS at 132. The mobile communication device 30 may also delete its copy of the authentication ticket. Deleting the ticket precludes the ticket from being used again, thereby controlling use of the authentication ticket. In other embodiments, the authentication ticket may comprise a counter value (noted above) that is decremented by the BIOS 22. The counter value may comprise a value of “1.” Upon decrementing the counter value, the value becomes “0.” The BIOS 22 may verify that the counter value in the authentication ticket is not 0 before passing the password to the operating system 24. If the counter value is a value of 0, the BIOS 22 does not pass the password to the operating system 24. In such embodiments, the authentication ticket can thus be used only once.

As noted above, the authentication ticket may comprise a passphrase used to decrypt the password. The authentication ticket may also comprise a new passphrase to be used in the event the password is changed by the user. If the user changes the password, the new password will be saved in the BIOS (or other storage location) in encrypted form, protected by the new passphrase.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method, comprising:
authenticating a wireless communication device;
receiving an authentication ticket from a server if said wireless communication device is successfully authenticated; and
providing said authentication ticket by said wireless communication device to a computer to enable the computer complete an initialization process.

2. The method of claim 1 further comprising authenticating a user of said wireless communication device.

3. The method of claim 2 wherein receiving the authentication ticket comprises receiving the authentication ticket from the server if both of said wireless communication device and said user are successfully authenticated.

4. The method of claim 1 further comprising the computer authenticating the authentication ticket.

5. The method of claim 1 further comprising providing a password to an operating system if said authentication ticket is successfully authenticated.

6. The method of claim 5 further comprising deleting the authentication ticket upon or after providing the password to the operating system.

7. The method of claim 5 further comprising forcing a user to change the password.

8. The method of claim 1 wherein authenticating the wireless communication device comprises comparing information unique to the wireless communication device to a template.

9. The method of claim 1 further comprising registering the wireless communication device with the server.

10. The method of claim 9 wherein registering the wireless communication device with the server comprises storing information unique to the wireless communication device on the server.

11. A system, comprising:
logic; and
a wireless transceiver;
wherein, via said wireless transceiver, said logic receives an authentication ticket from a server and provides said authentication ticket to a computer to enable the computer to complete a boot process.

12. The system of claim 11 wherein the logic authenticates a user of said system.

13. The system of claim 11 wherein said logic provides information unique to the system to the server to enable the server to authenticate the system.

14. The system of claim 11 wherein said system comprises a device selected from the group consisting of a cell phone, a smart phone, a mobile device, and a personal digital assistant (PDA).

15. The system 11 further wherein said system wirelessly provides said authentication ticket to said computer.

16. A system, comprising:
a processor that receives an authentication ticket from a wireless communication device, authenticates said ticket, and enables a boot process to complete if said ticket is successfully authenticated.

17. The system of claim 16 wherein said processor authenticates said ticket by comparing the received ticket to a template.

18. The system of claim 16 further comprising an operating system executable by said processor, wherein said processor enables the boot process complete by causing a password to be provided to the operating system.

19. The system of claim 18 wherein the processor forces a user to change the password.

20. The system of claim 16 wherein said system also authenticates a user of the wireless communication device.
